(19) United States
(12) Patent Application Publication
(10) Pub. No.: US 2026/0303951 A1
(43) Pub. Date: Oct. 1, 2026

(54) Image Saliency Based Smart Framing with Consideration of Tapping Position and Continuous Adjustment

(71) Applicant: Google LLC, Mountain View, CA (US)

(72) Inventors: Ruijin Cang, Santa Clara, CA (US); Wei Hong, Sunnyvale, CA (US); Steven David Hickson, Atlanta, GA (US)

(21) Appl. No.: 19/479,722

(22) PCT Filed: May 5, 2023
(86) PCT No.: PCT/US2023/021261

§ 371 Date: Oct. 28, 2025

(51) Int. Cl. H04N 23/63; H04N 23/611; H04N 23/69; H04N 23/90

(52) U.S. Cl. CPC H04N 23/632; H04N 23/611; H04N 23/69; H04N 23/90

(57) ABSTRACT

A method includes receiving a first user-indicated area associated with a displayed image. The method also includes determining a first saliency region based on the first user-indicated area and the displayed image. The method further includes causing a first zoomed-in image to be displayed based on the first saliency region. The method additionally includes receiving a second user-indicated area associated with the first zoomed-in image. The method further includes determining a second saliency region based on the second user-indicated area and the first zoomed-in image. The method also includes causing a second zoomed-in image to be displayed based on the second saliency region, where the second zoomed-in image is further zoomed in than the first zoomed-in image.

### BACKGROUND

Many modern computing devices, including mobile phones, personal computers, and tablets, include image capturing devices. Some image capturing devices are configured with telephoto capabilities.

### SUMMARY

In an embodiment, a method includes receiving a first user-indicated area associated with a displayed image. The method also includes determining a first saliency region based on the first user-indicated area and the displayed image. The method further includes causing a first zoomed-in image to be displayed based on the first saliency region. The method additionally includes receiving a second user-indicated area associated with the first zoomed-in image. The method also includes determining a second saliency region based on the second user-indicated area and the first zoomed-in image. The method further includes causing a second zoomed-in image to be displayed based on the second saliency region, where the second zoomed-in image is further zoomed in than the first zoomed-in image.

In another embodiment, a computer system includes a control system configured to receive a first user-indicated area associated with a displayed image. The control system is also configured to determine a first saliency region based on the first user-indicated area and the displayed image. The control system is further configured to cause a first zoomed-in image to be displayed based on the first saliency region. The control system is additionally configured to receive a second user-indicated area associated with the first zoomed-in image. The control system is further configured to determine a second saliency region based on the second user-indicated area and the first zoomed-in image. The control system is also configured to cause a second zoomed-in image to be displayed based on the second saliency region, wherein the second zoomed-in image is further zoomed in than the first zoomed-in image.

In a further embodiment, a non-transitory computer readable medium storing program instructions executable by one or more processors to cause the one or more processors to perform operations. The operations comprise receiving a first user-indicated area associated with a displayed image. The operations also comprise determining a first saliency region based on the first user-indicated area and the displayed image. The operations further comprise causing a first zoomed-in image to be displayed based on the first saliency region. The operations additionally comprise receiving a second user-indicated area associated with the first zoomed-in image. The operations also comprise determining a second saliency region based on the second user-indicated area and the first zoomed-in image. The operations further comprise causing a second zoomed-in image to be displayed based on the second saliency region, wherein the second zoomed-in image is further zoomed in than the first zoomed-in image.

In another embodiment, a system is provided that includes means for receiving a first user-indicated area associated with a displayed image. The system also includes means for determining a first saliency region based on the first user-indicated area and the displayed image. The system additionally includes means for causing a first zoomed-in image to be displayed based on the first saliency region. The system further includes means for receiving a second user-indicated area associated with the first zoomed-in image. The system additionally includes means for determining a second saliency region based on the second user-indicated area and the first zoomed-in image. The system also includes means for causing a second zoomed-in image to be displayed based on the second saliency region, wherein the second zoomed-in image is further zoomed in than the first zoomed-in image.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a diagram illustrating a training phase and an inference phase of one or more trained machine learning models in accordance with example embodiments.

FIG. 4a is an image, in accordance with example embodiments.

FIG. 4b is a heatmap, in accordance with example embodiments.

FIG. 5 illustrates a heatmap with a bounding box, in accordance with example embodiments.

FIG. 6 illustrates a flow chart of a method, in accordance with example embodiments.

FIG. 7 depicts an image of an environment, in accordance with example embodiments.

FIG. 8 depicts saliency regions in an image, in accordance with example embodiments.

FIG. 9 depicts a first zoomed-in image, in accordance with example embodiments.

FIG. 10 depicts user input at the first zoomed-in image, in accordance with example embodiments.

FIG. 11 depicts saliency regions in the first zoomed-in image, in accordance with example embodiments.

FIG. 12 depicts a second zoomed-in image, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

An image capturing device may be included in a computing system (e.g., a smartphone, laptop, among other examples). Additionally and/or alternatively, the image capturing device may be a remote image capturing device, which may communicate with a computing system (e.g., a smartphone, laptop, server device, among other examples). Regardless of whether the image capturing device is integrated within the computing system or remote from the computing system, the computing system may display a preview of an image that could be captured by the image capturing device. For instance, if a park is included in the field of view of the image capturing device, the image capturing device may send a preview including the park to the computing system, and the computing system may display the preview including the park as included in the field of view of the image capturing device.

An issue that may arise in this process is capturing an image that is properly zoomed-in. Having a fixed zoom ratio may be detrimental to capturing an image that includes all the details of the image. For instance, referring back to the preview of a field of view including the park, a user may wish to actually capture an image of a particular person in the park. Having a fixed zoom ratio may cause a preview of and/or capture of an image including a large portion of the park including all the people in the park. Therefore, it may be advantageous to be able to progressively zoom into the image such that the subject of the image is progressively narrowed down to include only the person. As another example, after zooming in, the image may include only part of the person. Therefore, it may be advantageous to automatically zoom out such that the image includes the entire person. As another example, an image may be of an office environment, which may include one or more subjects on which to zoom. In such an instance, it may also be advantageous to progressively zoom into the image, so that the computing system may capture all the subjects that the user wishes to capture.

Current techniques to adjust the zoom of an image sensor involve the users providing manual input, including for example, adjusting a knob or using two fingers on a touchscreen of the computing device to direct precisely how much to zoom in and/or out. Oftentimes, such manual adjustment of the zoom requires time and effort by the user. Ideally, an image capturing device could automatically achieve a suitable zoom for a photographic scene.

Described herein are techniques for image capturing devices to automatically and progressively zoom to areas of an image that are associated with various areas of interest in a photographic scene. In some examples, a user may provide user input at an user-indicated area, perhaps through a display displaying an image. The computing system may detect an area in the image that includes one or more portions that are salient. Based on the areas that are salient and the user-indicated area, the computing system may determine a zoomed-in image, perhaps through determining a zoom-ratio that indicates how far to zoom to primarily include the areas that are salient. After determining the zoomed-in image, the computing system may detect a further user input at a second user-indicated area. The computing system may again determine saliency regions based on the zoomed-in image. The saliency regions may change and may be more refined when only the zoomed-in image is considered instead of the initially displayed image. The saliency regions and the second user-indicated area may be used to further zoom into a scene. The computing system may repeat this process one or more times, perhaps until the zoomed-in image includes only one saliency region or part of one saliency region. Upon further user input, the computing system may determine a zoomed out image that returns the field of view of the image capturing device to the original field of view.

This process of progressively zooming into the image may help facilitate the accurate and automatic determination of where and/or how much to zoom. For example, in the previously mentioned park image, the computing system may first zoom to frame all the people in the image. Upon further user input at a particular area of the image, the computing system may zoom in further to include a particular person or a particular group of people in that particular area in the image. The computing system may repeat this process upon still further user input, perhaps until the image only includes a portion of the person. When the computing system determines that the image no longer includes any area to which to zoom and/or when the computing system determines that the zoomed-in image includes smaller than a threshold portion of the original image or less than a threshold number of pixels, the computing system may zoom out to include the original field of view of the image.

In some examples, the zoom mechanism may fall back to a default zoom ratio or original field of view under various conditions. For example, the computing system may use a default zoom ratio or original field of view when the computing system determines that the image is already zoomed in and a subsequently determined zoom ratio is too close in value to the zoom ratio at which the image is captured. This may occur when an image captured after zooming in is indistinguishable from an image captured before zooming in. In further examples, if the image is already zoomed in and a user double taps or otherwise provides a user input on a boundary of a viewfinder or display and/or an area that does not have a high saliency value, then the zoom mechanism may fall back to a default zoom or original field of view. Additionally and/or alternatively, the computing system may fall back to a default zoom ratio or original field of view when a tapped area is going to be partially or completely zoomed out of the viewfinder.

In some examples, to determine which areas to zoom to, the computing system may execute a visual saliency model, which may generate a visual saliency heatmap of the image. The visual saliency model may produce one or more bounding boxes including regions with areas of greatest visual saliency. For instance, in the image of a park with many people, the visual saliency heatmap may include bounding boxes for one or more people or one or more groups of people. As another example, in an image of an office, the visual saliency heatmap may include bounding boxes for one or more computers, one or more mugs, one or more tables, and/or one or more groups of objects (e.g., mugs on a table). The visual saliency model may be executed on progressively zoomed-in images to provide a more refined representation of saliency regions with the assistance of sequential user inputs.

Additionally and/or alternatively, the computing system may also use a face detection model to determine which areas of the image to zoom. For example, the computing system may detect one or more regions containing faces and the computing system may also determine one or more saliency regions, which may include regions containing the faces. The computing system may indicate that regions in the image containing faces are more salient than the other saliency regions. The computing system may determine how to zoom based on these regions. For example, when an image includes a region containing various faces and another region containing trees, the computing system may determine that the region containing the various faces is more salient than the region containing the trees. The computing system may thus prioritize zooming to the region containing the faces rather than the region containing the trees, unless a user indicates otherwise.

A user may provide input as to a particular one of the saliency regions on which to zoom. For instance, a user may double tap on a particular area of a display displaying the image. The computing system may select a saliency region on which to zoom based on the selected saliency region including the particular area.

In some examples, the process of zooming in and out may occur with respect to an image preview, such that zooming in and out occurs to one or more subsequent images. For instance, the image capturing device may send an image as a preview to the computing system, which may display the image. The user may indicate an area to zoom into, and the computing system may determine one or more saliency regions and a zoom ratio based on the image and the subjects in the image. In some examples, displaying a zoomed-in image based on the zoom ratio may involve a further image. For instance, the image capturing device may capture a zoomed-in image or crop a new captured image, and/or the computing system may otherwise receive another image with the state of the environment at a moment after the original image preview.

### II. Example Systems and Methods

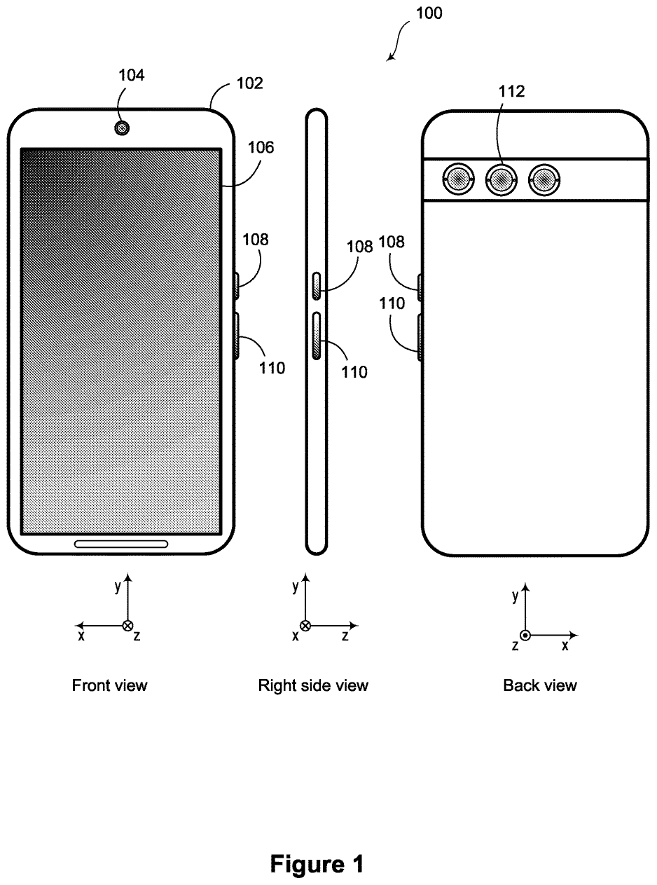

FIG. 1 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

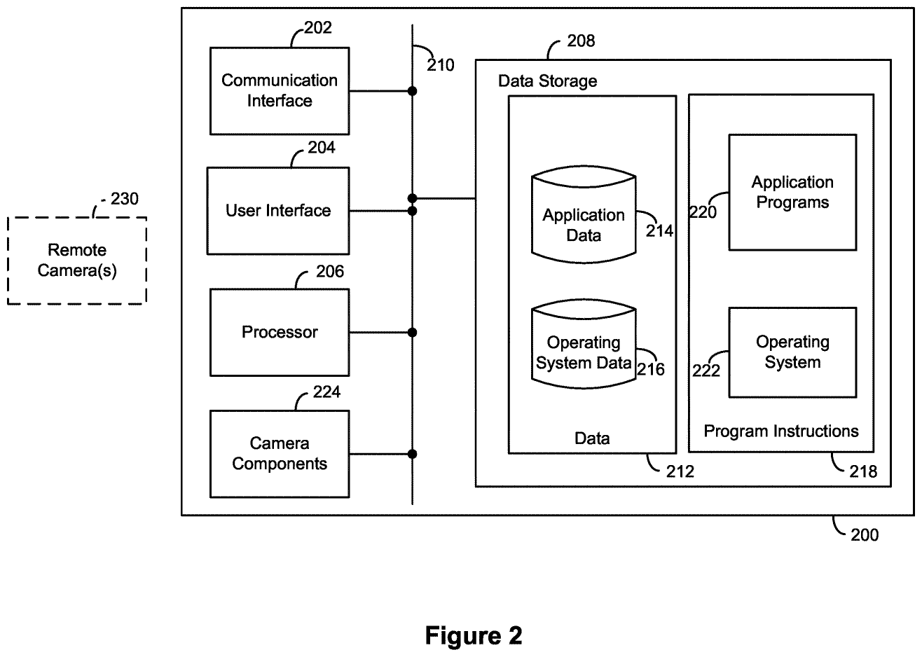

FIG. 2 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

In further examples, one or more remote cameras 230 may be controlled by computing system 200. For instance, computing system 200 may transmit control signals to the one or more remote cameras 230 through a wireless or wired connection. Such signals may be transmitted as part of an ambient computing environment. In such examples, inputs received at the computing system 200 (for instance, physical movements of a wearable device) may be mapped to movements or other functions of the one or more remote cameras 230. Images captured by the one or more remote cameras 230 may be transmitted to the computing system 200 for further processing. Such images may be treated as images captured by cameras physically located on the computing system 200.

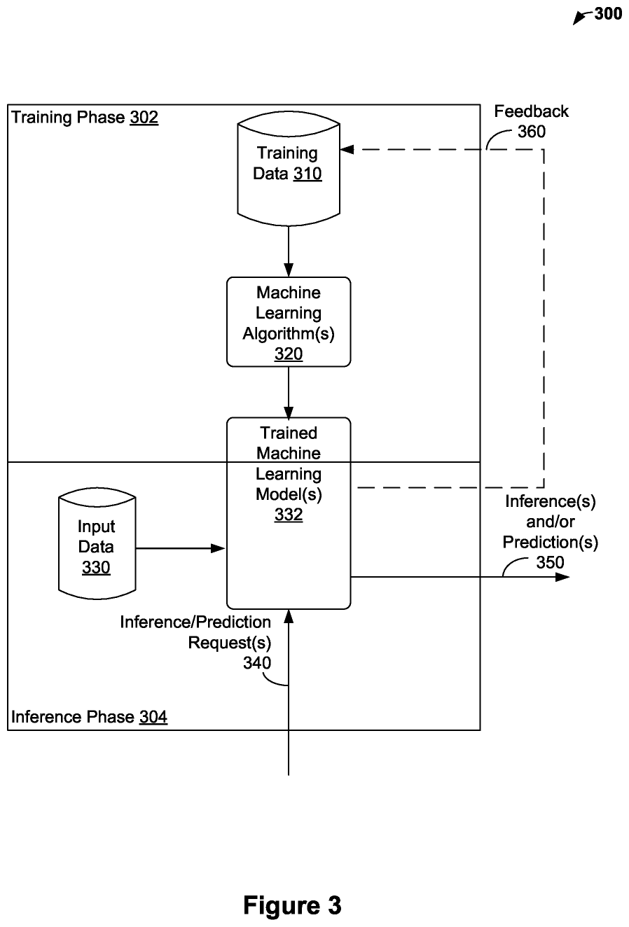

FIG. 3 shows diagram 300 illustrating a training phase 302 and an inference phase 304 of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Producing trained machine learning model(s) 332 during training phase 302 may involve determining one or more hyperparameters, such as one or more stride values for one or more layers of a machine learning model as described herein. Then, during inference phase 304, trained machine learning model 332 can receive input data 330 and one or more inference/prediction requests 340 (perhaps as part of input data 330) and responsively provide as an output one or more inferences and/or predictions 350. The one or more inferences and/or predictions 350 may be based in part on one or more learned hyperparameters, such as one or more learned stride values for one or more layers of a machine learning model as described herein As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results.

Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310. This further training of the machine learning algorithm(s) 320 and/or the pre-trained machine learning model using training data 310 of CD1's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

An example computing system as described herein may include an image capturing device. The image capturing device may include one or more cameras and sensors, among other components. The image capturing device may be part of the computing system (e.g., a smartphone, tablet, laptop, or digital camera, among other types of computing systems that may carry out the operations described herein). In some examples, the image capturing device may capture one or more images and send the images through wireless or wired communication. The computing system may display the image, perhaps as a preview of what could be captured by the image capturing device and/or of what is captured by the image capturing device.

As an example, a computing system may include one or more processors having logic for executing instructions, at least one built-in or peripheral image sensor (e.g., a camera), and an input/output device for displaying a user interface (e.g., a display panel). The computing system may further include a computer-readable medium (CRM). The CRM may include any suitable memory or storage device like random-access memory (RAM), static RAM (SRAM), dynamic RAM (DRAM), non-volatile RAM (NVRAM), read-only memory (ROM), or flash memory. The computing system stores device data (e.g., user data, multimedia data, applications, and/or an operating system of the device) on the CRM. The device data may include executable instructions for automatic zoom processes. The automatic zoom processes may be part of an operating system executing on the image capturing device, or may be a separate component executing within an application environment (e.g., a camera application) or a “framework” provided by the operating system.

The computing system may implement a machine-learned technique (“Visual Saliency Model”). The Visual Saliency Model may be implemented as one or more of a support vector machine (SVM), a recurrent neural network (RNN), a convolutional neural network (CNN), a dense neural network (DNN), one or more heuristics, other machine-learning techniques, a combination thereof, and so forth. The Visual Saliency Model may be iteratively trained, off-device, by exposure to training scenes, sequences, and/or events. For example, training may involve exposing the Visual Saliency Model to images (e.g., digital photographs), including user-drawn bounding boxes containing a visual saliency region (e.g., a region wherein one or more objects of particular interest to a user may reside). Exposure to images including user-drawn bounding boxes may facilitate training of the Visual Saliency Model to identify visual saliency regions within images. As a result of the training, the Visual Saliency Model can generate a visual saliency heatmap for a given image and produce a bounding box enclosing the region with the greatest probability of visual saliency. In this way, the Visual Saliency Model can predict visual saliency regions within images. After sufficient training, model compression using distillation can be implemented on the Visual Saliency Model enabling the selection of an optimal model architecture based on model latency and power consumption. The Visual Saliency Model can then be deployed to the CRM of the computing system as an independent module or implemented into the automatic zoom processes.

The computing system may carry out automatic zoom processes, perhaps automatically or in response to a received triggering signal, including, for example, a user-performed gesture (e.g., tapping, pressing) enacted on the input/output device. The computing system may receive one or more captured images from the image sensor.

The computing system may utilize the Visual Saliency Model to generate a visual saliency heatmap using the one or more captured images.

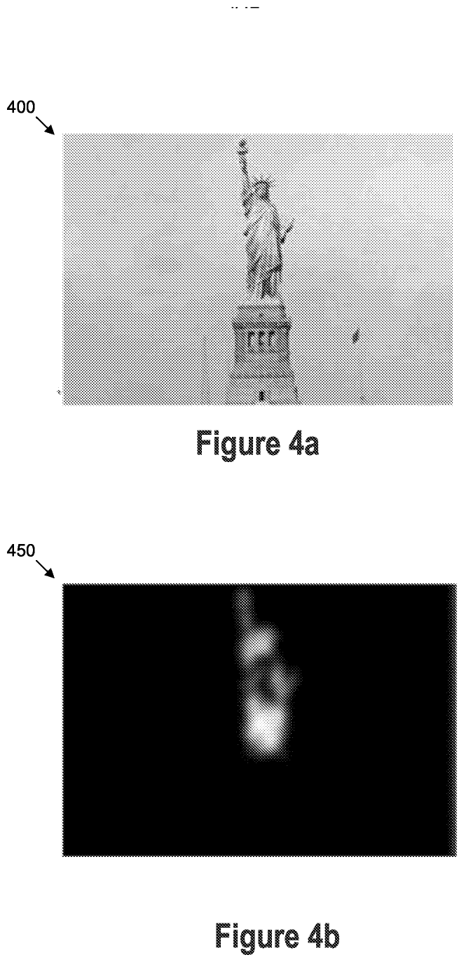

For example, FIG. 4a is an image 400, in accordance with example embodiments. FIG. 4b is a heatmap 450, in accordance with example embodiments. The computing system may utilize the Visual Saliency Model to generate a visual saliency heatmap of the captured image, as illustrated in FIGS. 4a and 4b. One or more processors calculate the visual saliency heatmap in the background operations of the device. In some examples, the image capturing device does not display the visual saliency heatmap to the user. As illustrated, the visual saliency heatmap depicts the magnitude of the visual saliency probability on a scale from black to white, where white indicates a high probability of saliency and black indicates a low probability of saliency.

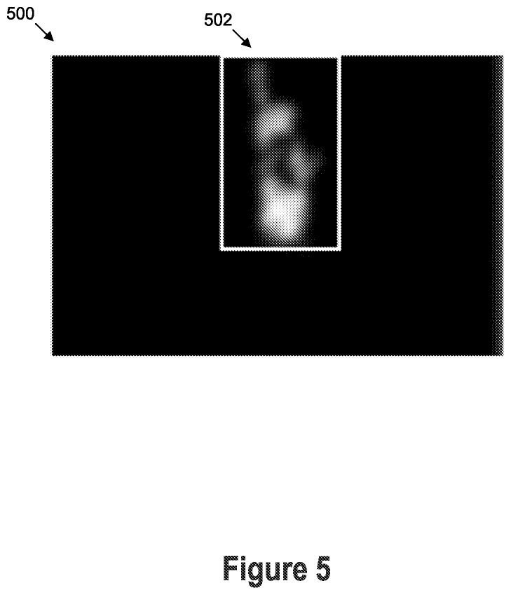

The Visual Saliency Model may produce a bounding box enclosing the region with the greatest probability of visual saliency. FIG. 5 illustrates a heatmap 500 with a bounding box 502, in accordance with example embodiments.

As illustrated in FIG. 5, the visual saliency heatmap includes a bounding box enclosing the region within the image containing the greatest probability of visual saliency. In the event that there are multiple objects of interest in a photographic scene, causing the Visual Saliency Model to identify multiple saliency regions within a captured image, the Visual Saliency Model can be trained to produce a bounding box enclosing the saliency region nearest the center of the captured image. This trained technique assumes that a user is interested in the most centralized object in the image. Alternatively, the Visual Saliency Model can be trained to produce a bounding box enclosing all the objects of interest in a captured image.

Using Equation 1, the computing system may calculate a targeted zoom ratio based on the bounding box dimensions:

$$zmRatio = max ( boundingBoxWidth / imageWidth , boundingBoxHeight / imageHeight ) \qquad ( 1 )$$

Equation 1 enables the computing system to calculate a zoom ratio (zmRatio) based on the bounding box width (boundingBoxWidth) and the image width (imageWidth), as well as the bounding box height (boundingBoxHeight) and the image height (imageHeight). The computing system may utilize the zoom ratio value to adjust the zoom settings of the image capturing device.

Adjusting the zoom settings may involve the computing system directing one or more processors to adjust the arrangement of the optical lenses of an image sensor (i.e., optical zoom). In another aspect, the computing system utilizes a different image sensor to implement the calculated zoom ratio. In yet another aspect, the computing system digitally edits and enhances the image. For example, the computing system may crop and scale up the image, as well as add pixels (i.e., digital zoom). A combination of these aspects (e.g., hybrid zoom) may be utilized to achieve a suitable zoom, as well.

In some examples, zooming in once to the salient regions in the image may be inadequate. For instance, for an image of an office space, there may be salient objects scattered throughout the environment. Automatically zooming in once to a salient region may result in the image including too few salient regions and/or too many salient regions. Further, the computing system may be unable to differentiate between two or more salient regions when the image is zoomed out, as the resolution of each region may be lower than when the image is zoomed in. Therefore, it may be advantageous to progressively zoom in as the user provides input indicating the one or more regions to zoom in to.

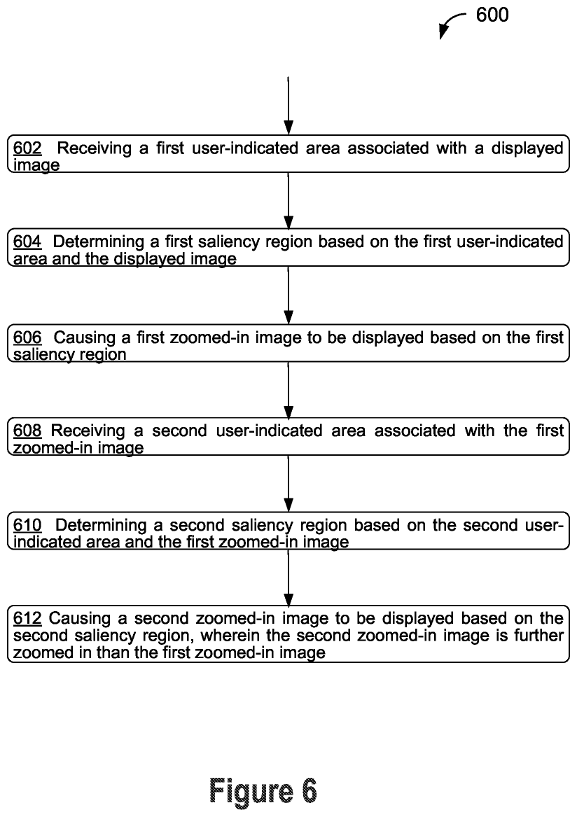

FIG. 6 is a flow chart of method 600, in accordance with example embodiments. Method 600 may be executed by one or more computing systems (e.g., computing system 200 of FIG. 2) and/or one or more processors (e.g., processor 206 of FIG. 2). Method 600 may be carried out on a computing system, such as computing system 100 of FIG. 1.

At block 602, method 600 includes receiving a first user-indicated area associated with a displayed image. A computing system may receive an image to display from an image capturing device, perhaps as part of an image preview, image capture, or video preview. A user may indicate an area to which to zoom by way of a display of the computing system. For instance, a user may double tap on the middle of the display and/or the middle of a display displaying the image to indicate to zoom to the middle of the image.

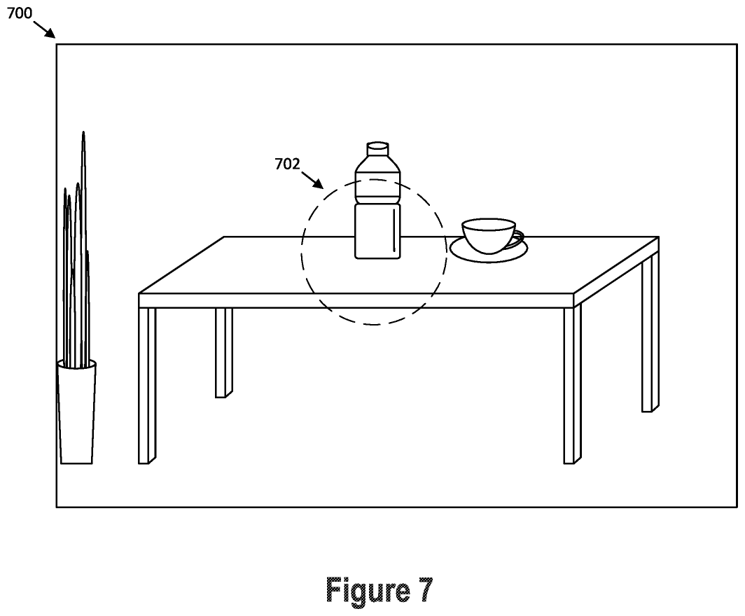

FIG. 7 depicts image 700 of an environment. The computing system may receive image 700 of the environment from an image capturing device included in the computing system. In some examples, image 700 may be an image that is not zoomed in. The computing system may display image 700, perhaps through a display, touchscreen, or other display device. As shown, image 700 may include a plant, a table, a water bottle, and a mug. The user may double tap, click, or otherwise indicate an area of the screen corresponding to user-indicated area 702.

Referring back to FIG. 6, at block 604, method 600 includes determining a first saliency region based on the first user-indicated area and the displayed image. The computing system may determine the first saliency region based on applying the visual saliency model described above to an image.

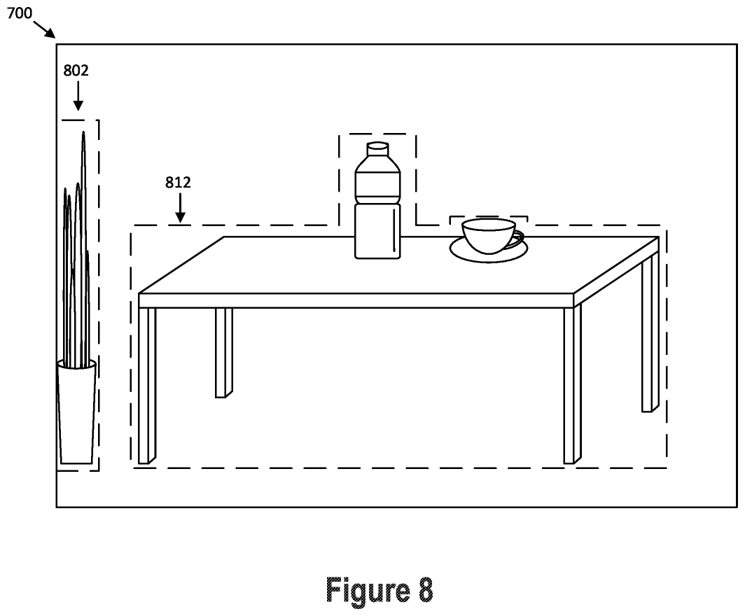

As an example, FIG. 8 depicts saliency regions in image 700, in accordance with example embodiments. The computing system may use displayed image 700 to determine saliency regions 802 and 812. In some examples, one or more of the saliency regions may be combined saliency regions. For instance, saliency region 812 may be determined by detecting that the region including the table is salient, the region including the water bottle is salient, and the region including the mug is salient. These saliency regions may overlap and/or be close to one another. Therefore, the computing system may be unable to differentiate between these different saliency regions, but the computing system may determine saliency region 812 such that saliency region 812 includes the area with the mug, the area with the table, and the area with the water bottle. However, saliency region 802, which includes a plant, may be separate from saliency region 812 because saliency region 802 may be a threshold distance away from saliency region 812. Additionally and/or alternatively, individual elements in saliency region 812 may be indistinguishable from each other, thereby causing the computing system to determine two saliency regions—saliency region 802 and saliency region 814.

The computing system may determine which saliency region to use for zooming based on user input. For instance, referring back to FIG. 7, the user provided an indication at area 702. The indication at area 702 may include part of the area indicated in saliency region 812, but none of the area indicated in saliency region 802. Therefore, based on the user provided indication at area 702, the computing system may determine to zoom into saliency region 812.

Referring back to FIG. 6, at block 606, method 600 includes causing a first zoomed-in image to be displayed based on the first saliency region. Based on the saliency region, the computing system may determine a zoom ratio or other indication that communicates to the image capturing device how much to zoom and/or where to zoom. In some examples, the image capturing device may use the indication to adjust the optical settings of the image capturing device. Additionally and/or alternatively, the image capturing device may adjust the zoom ratio and location at which to zoom based on an image captured by the image capturing device.

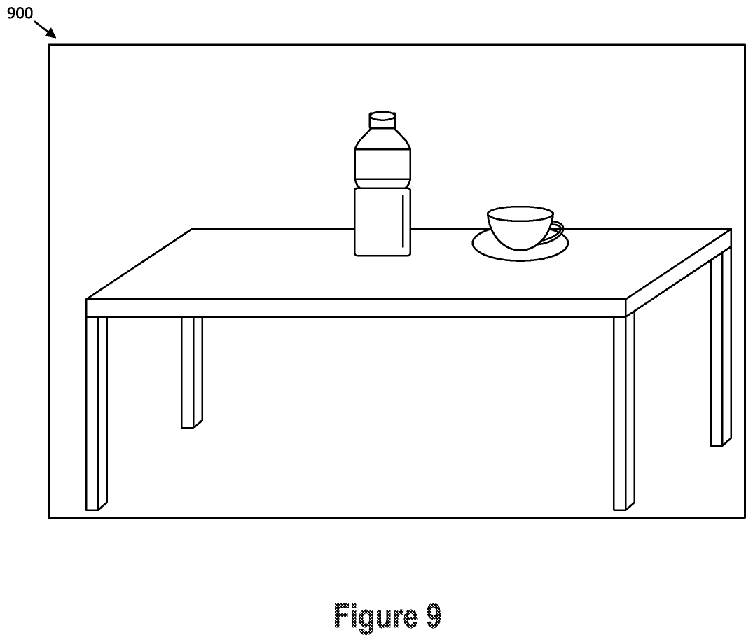

FIG. 9 depicts a first zoomed-in image 900, in accordance with example embodiments. The computing system may determine first zoomed-in image 900 by determining a zoom ratio at which to zoom based on salient region 812 of image 700. The zoom ratio may be a ratio at which the image capturing device or the computing system may zoom into the image such that the entirety or a large portion of the saliency region is included.

For instance, the computing system may determine a zoom ratio from image 700 that includes saliency region 812 and by applying the determined zoom ratio, the computing system may determine first zoomed-in image 900 based on that zoom ratio. First zoomed-in image 900 may include space above and to the right of the table when limited to center zooming to include the entirety of salient region 812.

Additionally and/or alternatively, the computing system may zoom into another area in the image that is not the center (e.g., an area that is off center of the image). If the computing system had zoomed off center, the image may include less space around a salient region. For instance, first zoomed-in image 900 may not include the area above and to the right of the table, as the area does not include a part of salient region 812.

To determine the zoomed-in image, the computing system may apply a digital zoom and/or an optical zoom. For instance, to determine the zoomed-in image based on applying optical zoom, the computing system may send an indication to the image capturing device to adjust the lens and/or other camera components to capture an image at a particular zoom ratio. To determine the zoomed-in image based on applying digital zoom, the computing system may receive an image from the image capturing device, and the computing system may then crop and scale up the image, perhaps as part of an image post processing process.

As mentioned above, the computing system may progressively refine the field of view of the image. In line with this process, the computing system may determine a less restrictive zoom ratio, particularly if the computing system is zooming in for the first time. For instance, the computing system may be able to determine that each of the objects on the table are separate objects, and that the user input indicated the water bottle. However, the computing system may nevertheless determine a zoom ratio that includes the table and both of the objects on the table, as it may be unclear whether the user actually intended on zooming to the water bottle in image 700. The user may provide a further user input to zoom in further.

Referring back to FIG. 6, at block 608, method 600 includes receiving a second user-indicated area associated with the first zoomed-in image. As mentioned above, the computing system may determine and display first zoomed-in image 900 on a display or screen of the computing system, perhaps based on user input to the display or screen. A user may double tap or provide other indications to further refine the field of view of the image.

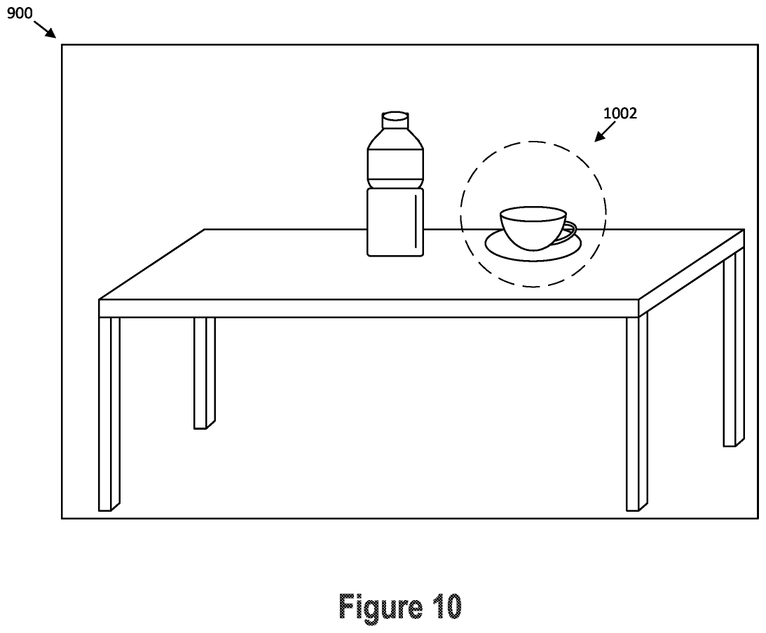

As an example, FIG. 10 depicts user input at first zoomed-in image 900, in accordance with example embodiments. The computing system may display zoomed-in image 900, and a user may double tap or otherwise indicate an area to which to zoom, such as user-indicated area 1002. The process of detecting and determining user-indicated area 1002 may be similar to the process described above with respect to area 702 of FIG. 7.

Referring back to FIG. 6, at block 610, method 600 includes determining a second saliency region based on the second user-indicated area and the first zoomed-in image. To determine a second saliency region, the computing system may apply a saliency model to the first zoomed-in image. The computing system may evaluate the saliency heatmap based on the saliency of all the elements in the image. For instance, if a large portion of the image is salient, the computing system may determine the second saliency region based on determining one or more regions that are most salient.

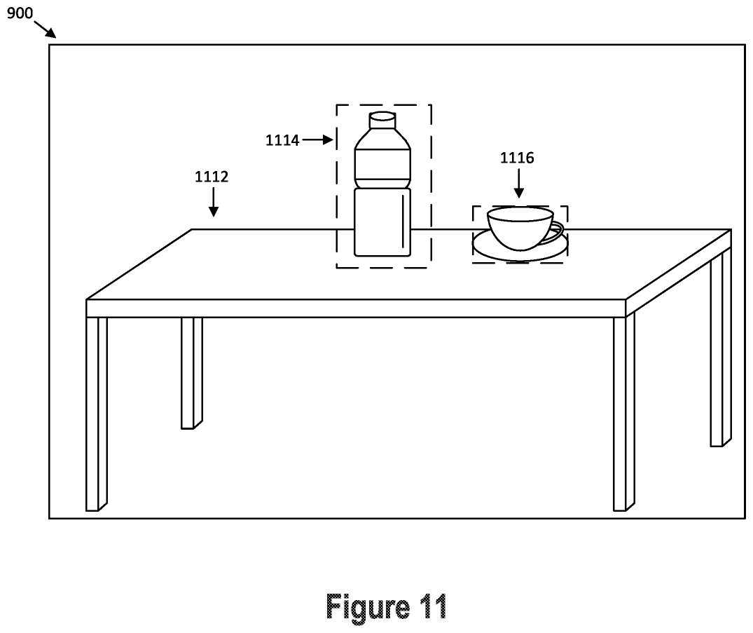

FIG. 11 depicts saliency regions in first zoomed-in image 900, in accordance with example embodiments. Image 900 includes salient region 1114 of a water bottle and salient region 1116 of a mug. The computing system may determine that table 1112 is also salient but perhaps not as salient as salient region 1114 and salient region 1116.

In determining whether to zoom in on salient region 1114 or salient region 1116, the computing system may determine that the user-indicated area includes salient region 1116, but not salient region 1114. Therefore, the computing system may determine a zoom ratio or another indication of how to zoom based on salient region 1116, such that the zoom ratio or other indication of how to zoom would include the salient region 1116.

Referring back to FIG. 6 at block 612, method 600 includes causing a second zoomed-in image to be displayed based on the second saliency region, wherein the second zoomed-in image is further zoomed in than the first zoomed-in image. A computing system further zooming into the first zoomed-in image may execute a similar process as discussed above, where zooming in may be based on center zoom or zooming to a particular region in the image.

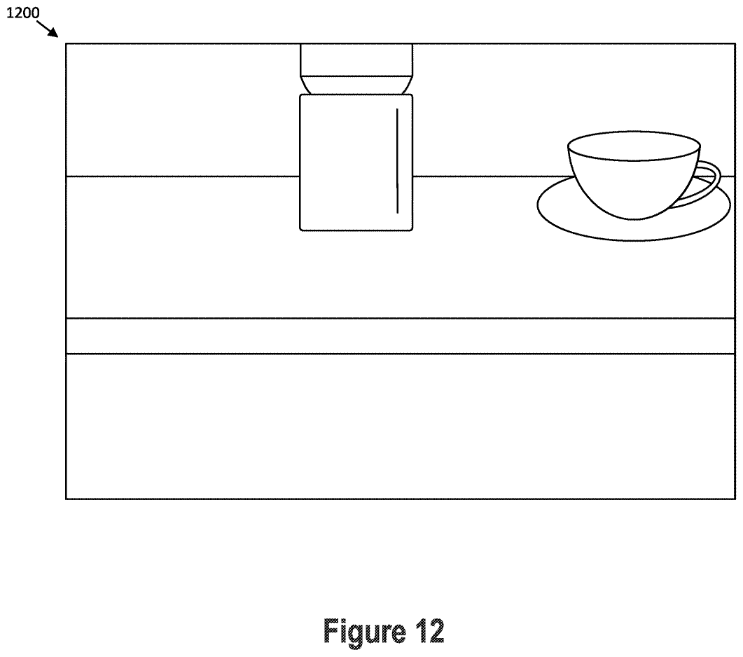

FIG. 12 depicts a second zoomed-in image 1200, in accordance with example embodiments. The computing system may have determined zoomed-in image 1200 by zooming into the center of first zoomed-in image 900, such that zoomed-in image 1200 includes the saliency region. Because the computing system may have determined zoomed-in image 1200 as limited by center zooming, zoomed-in image 1200 may still include portions of subjects in the center of the image, such as the water bottle. However, in some examples, the subjects may be cropped out of the image, as the subjects are not the area that is most salient and/or the area that the user indicated.

In some examples, the computing system may include one or more cameras as part of the image capturing device, where each camera includes different optical zooms. For instance, the computing system may include a camera with a wide angle lens, a camera that captures images without optical zoom, and a camera with a particular amount of optical zoom. The computing system may first capture images and/or determine zoomed-in images using the camera without optical zoom. After determining one or more images, the computing system may determine that the zoom ratio is above the particular amount of optical zoom, and the computing system may send an indication to the image capturing device to capture images from the camera with the particular amount of optical zoom.

In some examples, the computing system may determine to zoom out to an original field of view or original zoom ratio. For instance, after zooming in one or more times, the computing system may determine that the saliency region includes a large portion of the image and may be unable to determine a region of the image to which to zoom. Additionally and/or alternatively, the computing system may determine that zooming in again at a further zoom ratio would result in a new zoom ratio that is too close in value to the zoom ratio at which the image is captured, which may cause an image captured after zooming in to the new zoom ratio to be indistinguishable from an image captured before zooming in to the new zoom ratio. To determine whether the subsequently determined zoom ratio is too close in value to the zoom ratio at which the image was captured, the computing system may compare the difference between the subsequently determined zoom ratio and the initial zoom ratio to a zoom threshold. For example, the zoom threshold may be set to 1.2×. If the difference between the subsequently determined zoom ratio and the initial zoom ratio at which the image was captured is less than 1.2×, then the computing system may fall back to the default zoom ratio or the original field of view.

In some examples, the computing system may detect a user input (e.g., double tapping) associated with a particular location on a display or viewfinder (e.g., an edge or boundary of the display), and the computing system may further detect that the particular location is associated with a saliency value lesser than a threshold saliency value. For instance, a user may tap on an edge or boundary of the display or viewfinder, which may be associated with an area of an image depicting a ground surface having a particular saliency value, causing the user-indicated area to be the ground surface. The computing system may determine saliency regions having associated saliency values, and the computing system may determine that the saliency region at the user-indicated area is associated with a saliency value lower than a threshold value, perhaps indicating that the user-indicated area does not include an area worth zooming in to. Based on this determination, the computing system may send an indication to the camera or other image capturing device to zoom out to an original field of view or an original zoom ratio.

Additionally and/or alternatively, the computing system may fall back to a default zoom ratio or original field of view when a tapped area or other user-indicated area is going to be partially or completely zoomed out of the viewfinder. For instance, if the computing system detects a user-indicated area on the edge of the viewfinder, the computing system may have to zoom to cut out at least part of an object, if any, at the edge of the viewfinder to achieve a discernible or useful zoom. Therefore, if the computing system determines that zooming in would cause at least part of or an entirety of an object and/or a saliency area to be excluded, the computing system may send an indication to the image capturing device to zoom out.

The methods mentioned above may be used in conjunction or as alternatives of each other to determine whether to further zoom in or to zoom out and may involve multiple cameras or other image capturing devices. In some examples, zooming out may involve the computing system sending an indication to the image capturing device to capture images using the wide angle lens rather than the camera without any optical zoom. Additionally and/or alternatively, zooming out may involve the computing system sending an indication to the image capturing device to switch to capturing images from a camera without any optical zoom rather than a camera with optical zoom.

In some examples, method 600 further comprises determining the first zoomed-in image based on inputting the displayed image into a saliency model, and determining the second zoomed-in image based on inputting the first zoomed-in image into the saliency model.

In some examples, method 600 further comprises determining the first zoomed-in image based on inputting the displayed image into a face detection model and determining the second zoomed-in image based on inputting the first zoomed-in image into the face detection model.

In some examples, determining the first saliency region is based on applying a machine learning model to the displayed image, wherein determining the second saliency region is based on applying the machine learning model to the first zoomed-in image.

In some examples, determining the second saliency region based on the second user-indicated area and the first zoomed-in image comprises determining a plurality of saliency regions based on the first zoomed-in image, wherein the plurality of saliency regions includes the second saliency region.

In some examples, determining the second saliency region based on the second user-indicated area and the first zoomed-in image further comprises selecting the second saliency region from the plurality of saliency regions based on the second saliency region being the most salient.

In some examples, determining the second saliency region based on the second user-indicated area and the first zoomed-in image further comprises selecting the second saliency region from the plurality of saliency regions based on the second saliency region including at least part of the second user-indicated area.

In some examples, receiving the first user-indicated area associated with the displayed image is based on detecting a tapping gesture on a particular region of a display displaying the displayed image, where receiving the second user-indicated area associated with the first zoomed-in image is based on detecting a further tapping gesture on a further particular region of the display displaying the first zoomed-in image.

In some examples, the displayed image is captured by a camera system, the method further comprising determining a zoom ratio based on the second saliency region and the first zoomed-in image and adjusting the camera system to capture the second zoomed-in image based on the determined zoom ratio.

In some examples, method 600 further comprises determining a zoom ratio based on the second saliency region and the first zoomed-in image and determining the second zoomed-in image by cropping further received images at the determined zoom ratio.

In some examples, method 600 further comprises determining a zoom ratio based on the second saliency region and the first zoomed-in image and determining the second zoomed-in image based on the zoom ratio and a center zoom position.

In some examples, method 600 further comprises determining a zoom ratio and a zoom position based on the second saliency region and the first zoomed-in image and determining the second zoomed-in image based on the zoom ratio and the zoom position.

In some examples, the first zoomed-in image is based on a first received image and the second zoomed-in image is based on a second, later received image.

In some examples, method 600 further comprises receiving a third user-indicated area associated with the second zoomed-in image, determining a third saliency region based on the third user-indicated area and the second zoomed-in image, and causing a third image to be displayed based on the third saliency region.

In some examples, the displayed image is associated with an original zoom ratio. Method 600 further comprises determining that the third saliency region includes a threshold portion of the second zoomed-in image and in response to determining that the third saliency region includes the threshold portion of the second zoomed-in image, determining the third image at the original zoom ratio.

In some examples, the displayed image is associated with an original zoom ratio. Method 600 further comprises determining a third zoom ratio based on the third saliency region and the second zoomed-in image, determining that the third zoom ratio is less than a zoom threshold from a second zoom ratio for the second zoomed-in image, and based on determining that the third zoom ratio is less than the zoom threshold from the second zoom ratio for the second zoomed-in image, determining the third image at the original zoom ratio.

In some examples, the displayed image is associated with an original zoom ratio. Method 600 further comprises determining that the third user-indicated area is at a boundary of the second zoomed-in image and that a saliency value of the third user-indicated area is less than a threshold low saliency value and based on determining that the third user-indicated area is at a boundary of the second zoomed-in image and that a saliency value of the third user-indicated area is less than a threshold low saliency value, determining the third image at the original zoom ratio.

In some examples, the displayed image is associated with an original zoom ratio. Method 600 further comprises determining that zooming to the third user-specified area causes the third image to not include part of or an entirety of the third saliency area, and in response to determining that zooming to the third user-specified area causes the third image to not include part of or an entirety of the third saliency area, determining the third image at the original zoom ratio.

In some examples, method 600 further comprises determining that the third saliency region does not include a threshold portion of the second zoomed-in image and, based on determining that the third saliency region does not include the threshold portion of the second zoomed-in image, determining a third zoomed-in image as the third image. The third zoomed-in image is further zoomed in than the second zoomed-in image.

In some examples, method 600 is carried out by a control system of a computing system.

In some examples, the computing system further comprises a camera system. The camera system includes a first camera associated with a first optical zoom and a second camera associated with a second optical zoom, where the first zoomed-in image is based on an image received from the first camera. The control system is configured to cause the second zoomed-in image to be displayed based on the second saliency region by determining a zoom ratio based on the second saliency region and the first zoomed-in image, determining that the zoom ratio is greater than the second optical zoom, and, based on determining that the zoom ratio is greater than the second optical zoom, receiving the second zoomed-in image from the second camera.

In some examples, the computing system further comprises a display that is configured to display the displayed image and the second zoomed-in image, where the control system is configured to receive the first user-indicated area based on user input detected at a particular area of the display, where the control system is configured to receive the second user-indicated area based on another user input at another particular area of the display.

In some examples, a non-transitory computer readable medium storing program instructions executable by one or more processors to cause the one or more processors to perform operations comprising those of method 600 and those described above.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
receiving a first user-indicated area associated with a displayed image;
determining a first saliency region based on the first user-indicated area and the displayed image;
causing a first zoomed-in image to be displayed based on the first saliency region;
receiving a second user-indicated area associated with the first zoomed-in image;
determining a second saliency region based on the second user-indicated area and the first zoomed-in image; and
causing a second zoomed-in image to be displayed based on the second saliency region, wherein the second zoomed-in image is further zoomed in than the first zoomed-in image.

2. The method of claim 1, further comprising:
determining the first zoomed-in image based on inputting the displayed image into a saliency model; and
determining the second zoomed-in image based on inputting the first zoomed-in image into the saliency model.

3. The method of claim 1, further comprising:
determining the first zoomed-in image based on inputting the displayed image into a face detection model; and
determining the second zoomed-in image based on inputting the first zoomed-in image into the face detection model.

4. The method of claim 1, wherein determining the first saliency region is based on applying a machine learning model to the displayed image, wherein determining the second saliency region is based on applying the machine learning model to the first zoomed-in image.

5. The method of claim 1, wherein determining the second saliency region based on the second user-indicated area and the first zoomed-in image comprises:
determining a plurality of saliency regions based on the first zoomed-in image, wherein the plurality of saliency regions includes the second saliency region.

6. The method of claim 5, wherein determining the second saliency region based on the second user-indicated area and the first zoomed-in image further comprises:
selecting the second saliency region from the plurality of saliency regions based on the second saliency region being the most salient.

7. The method of claim 5, wherein determining the second saliency region based on the second user-indicated area and the first zoomed-in image further comprises:
selecting the second saliency region from the plurality of saliency regions based on the second saliency region including at least part of the second user-indicated area.

8. The method of claim 1, wherein receiving the first user-indicated area associated with the displayed image is based on detecting a tapping gesture on a particular region of a display displaying the displayed image, wherein receiving the second user-indicated area associated with the first zoomed-in image is based on detecting a further tapping gesture on a further particular region of the display displaying the first zoomed-in image.

9. The method of claim 1, wherein the displayed image is captured by a camera system, the method further comprising:
determining a zoom ratio based on the second saliency region and the first zoomed-in image; and
adjusting the camera system to capture the second zoomed-in image based on the determined zoom ratio.

10. The method of claim 1, further comprising:
determining a zoom ratio based on the second saliency region and the first zoomed-in image; and
determining the second zoomed-in image by cropping further received images at the determined zoom ratio.

11. The method of claim 1, further comprising:
determining a zoom ratio based on the second saliency region and the first zoomed-in image; and
determining the second zoomed-in image based on the zoom ratio and a center zoom position.

12. The method of claim 1, further comprising:
determining a zoom ratio and a zoom position based on the second saliency region and the first zoomed-in image; and
determining the second zoomed-in image based on the zoom ratio and the zoom position.

13. The method of claim 1, wherein the first zoomed-in image is based on a first received image and the second zoomed-in image is based on a second, later received image.

14. The method of claim 1, further comprising:
receiving a third user-indicated area associated with the second zoomed-in image;
determining a third saliency region based on the third user-indicated area and the second zoomed-in image; and
causing a third image to be displayed based on the third saliency region.

15. The method of claim 14, wherein the displayed image is associated with an original zoom ratio, wherein the method further comprises:
determining that the third saliency region includes a threshold portion of the second zoomed-in image; and
in response to determining that the third saliency region includes the threshold portion of the second zoomed-in image, determining the third image at the original zoom ratio.

16. The method of claim 14, wherein the displayed image is associated with an original zoom ratio, wherein the method further comprises:
determining a third zoom ratio based on the third saliency region and the second zoomed-in image;
determining that the third zoom ratio is less than a zoom threshold from a second zoom ratio for the second zoomed-in image; and
based on determining that the third zoom ratio is less than the zoom threshold from the second zoom ratio for the second zoomed-in image, determining the third image at the original zoom ratio.

17. The method of claim 14, wherein the displayed image is associated with an original zoom ratio, wherein the method further comprises:
determining that the third user-indicated area is at a boundary of the second zoomed-in image and that a saliency value of the third user-indicated area is less than a threshold low saliency value; and
based on determining that the third user-indicated area is at a boundary of the second zoomed-in image and that a saliency value of the third user-indicated area is less than a threshold low saliency value, determining the third image at the original zoom ratio.

18. The method of claim 14, wherein the displayed image is associated with an original zoom ratio, wherein the method further comprises:
determining that zooming to the third user-specified area causes the third image to not include part of or an entirety of the third saliency area; and
in response to determining that zooming to the third user-specified area causes the third image to not include part of or an entirety of the third saliency area, determining the third image at the original zoom ratio.

19. The method of claim 14, wherein the method further comprises:
determining that the third saliency region does not include a threshold portion of the second zoomed-in image; and
based on determining that the third saliency region does not include the threshold portion of the second zoomed-in image, determining a third zoomed-in image as the third image, wherein the third zoomed-in image is further zoomed in than the second zoomed-in image.

20. A computing system comprising:
a control system configured to:
receive a first user-indicated area associated with a displayed image;
determine a first saliency region based on the first user-indicated area and the displayed image;
cause a first zoomed-in image to be displayed based on the first saliency region;
receive a second user-indicated area associated with the first zoomed-in image;
determine a second saliency region based on the second user-indicated area and the first zoomed-in image; and
cause a second zoomed-in image to be displayed based on the second saliency region, wherein the second zoomed-in image is further zoomed in than the first zoomed-in image.

21. The computing system of claim 20, further comprising a camera system, wherein the camera system includes a first camera associated with a first optical zoom and a second camera associated with a second optical zoom, wherein the first zoomed-in image is based on an image received from the first camera, wherein the control system is configured to cause the second zoomed-in image to be displayed based on the second saliency region by: determining a zoom ratio based on the second saliency region and the first zoomed-in image;
determining that the zoom ratio is greater than the second optical zoom; and
based on determining that the zoom ratio is greater than the second optical zoom, receiving the second zoomed-in image from the second camera.

22. The computing system of claim 20, further comprising a display that is configured to display the displayed image and the second zoomed-in image, wherein the control system is configured to receive the first user-indicated area based on user input detected at a particular area of the display, wherein the control system is configured to receive the second user-indicated area based on another user input at another particular area of the display.

23. A non-transitory computer readable medium storing program instructions executable by one or more processors to cause the one or more processors to perform operations comprising:
receiving a first user-indicated area associated with a displayed image;
determining a first saliency region based on the first user-indicated area and the displayed image;
causing a first zoomed-in image to be displayed based on the first saliency region;
receiving a second user-indicated area associated with the first zoomed-in image;
determining a second saliency region based on the second user-indicated area and the first zoomed-in image; and
causing a second zoomed-in image to be displayed based on the second saliency region, wherein the second zoomed-in image is further zoomed in than the first zoomed-in image.
